(19) United States
(12) Patent Application Publication
(10) Pub. No.: US 2017/0168609 A1
(43) Pub. Date: Jun. 15, 2017

(54) MUTUAL CAPACITIVE TOUCH SENSING DEVICE OF TOUCH PANEL

(71) Applicant: MStar Semiconductor, Inc., Hsinchu Hsien (TW)

(72) Inventors: Hu-Chi Chang, Hsinchu County (TW); Wei-Lun Kuo, Hsinchu County (TW)

(21) Appl. No.: 15/363,396

(22) Filed: Nov. 29, 2016

Related U.S. Application Data
(60) Provisional application No. 62/264,870, filed on Dec. 9, 2015.

(51) Int. Cl. G06F 3/044; G06F 3/041

(52) U.S. Cl. CPC G06F 3/044; G06F 3/0416; G06F 2203/04107

(57) ABSTRACT

A mutual capacitive touch sensing device of a touch panel includes a plurality of touch sensing groups arranged along a first direction. Each touch sensing group includes a first electrode, a plurality of second electrodes and a plurality of third electrodes. The first electrode is disposed on a substrate in a serpentine shape, and includes a first side and a second side that are opposite. The first side includes a plurality of first indentations, and the second side includes a plurality of second indentations, with the first indentations and the second indentations alternately arranged along a second direction. One of the first indentations and one of the second indentations that are adjacent do not overlap in the first direction. The second electrodes are respectively disposed in the corresponding first indentations, and the third electrodes are respectively disposed in the corresponding second indentations.

This application claims the benefit of U.S. Provisional Application Ser. No. 62/264,870, filed Dec. 9, 2015, the subject matter of which is incorporated herein by reference.

### BACKGROUND OF THE INVENTION

Field of the Invention

The invention relates in general to a mutual capacitive touch sensing device, and more particularly, to a mutual capacitive touch sensing device including touch control units that do not overlap in the horizontal direction.

Description of the Related Art

With the progress of technologies, touch panels, featuring human-machine interactions, are extensively applied in electronic products including smart phones, GPS navigator systems, tablet computers and laptop computers. A touch sensing device in a conventional mutual capacitive touch panel is formed by a plurality of driving electrodes and a plurality of sensing electrodes in a staggered arrangement. The driving electrodes and the sensing electrodes are formed by two conductive layers to prevent these two types of electrodes from electrically connecting to each other. To form a mutual capacitive touch sensing device using the two conductive layers, an insulation layer is required in between to insulate the two layers from each other. However, the additional insulation layer inevitably restricts the thickness of the touch panel. Therefore, a single-layer mutual capacitive touch sensing device has been evolved.

FIG. 1 shows a top view of a conventional mutual capacitive touch sensing device. In a conventional single-layer structure, each sensing electrode 11 of a mutual capacitive touch sensing device 10 is disposed correspondingly to a plurality of driving electrodes 12 to form a touch sensing group 13. In each touch sensing group 13, the sensing electrode 11 is a long strip-shaped, and the driving electrodes 12 are disposed at two sides of the sensing electrode 11 and arranged along the sensing electrode 11 in a staggered manner, such that the driving electrodes 12 at one side of the sensing electrode 11 overlap the driving electrodes 13 at the other side along a direction perpendicular to the sensing electrode 11. FIG. 2 shows the driving electrodes 12 and the corresponding sensing electrode 11 together forming a touch sensing unit 14 in the conventional mutual capacitive touch sensing device 10, and so the touch sensing groups 13 form the touch sensing units 14 that arranged in two columns in a staggered manner. Compared to the design of the driving electrodes 12 arranged side by side at the two sides of the sensing electrode 11, the staggered arrangement increases sensitivity and reduces the number of driving electrodes 12. However, also because of the staggered arrangement of the driving electrodes 12, vertically fluctuating detection signals are generated when detecting a finger that moves in a straight line along a direction perpendicular to the sensing electrode 12, in a way that a detected motion track 15 does not match an actual motion track of the finger, hence resulting in inaccurate detection.

### SUMMARY OF THE INVENTION

It is a primary object of the present invention to provide a mutual capacitive touch sensing device of a touch panel to improve the prior arts and to enhance detection accuracy.

According to an embodiment of the present invention, a mutual capacitive touch sensing device of a touch panel is provided. The mutual capacitive touch sensing device, disposed on a substrate, being a single-layer structure, includes at least one touch sensing group arranged along a first direction on the substrate. The touch sensing group includes a first electrode, a plurality of second electrodes and a plurality of third electrodes. The first electrode is disposed in a serpentine shape on the substrate, and includes a first side and a second side that are opposite. The first side includes a plurality of first indentations, the second side includes a plurality of second indentations, and the first indentations and the second indentations are arranged along a second direction. One of the first indentations and one of the second indentations that are adjacent do no overlap in the first direction. The second electrodes are disposed facing the first side of the first electrode, and are respectively located in the corresponding first indentations. The third electrodes are disposed facing the second side of the first electrode, and are respectively located in the corresponding second indentations.

In the mutual capacitive touch sensing device of the present invention, as the first electrode is in a serpentine shape, the first indentation and the second indentation that are adjacent to each other do not overlap in the first direction, in a way that touch sensing units formed do not overlap in the first direction. Thus, when a touch object moves in a straight line along the first direction, a ratio of coupling areas of the touch object and the adjacent touch sensing units is kept consistent. As a result, the motion track detected by the mutual capacitive touch sensing device matches or approximates the actual motion track of the touch object, thereby enhancing the accuracy of touch sensing and preventing the issue of a detected motion track deviating from the actual motion track of the touch object.

The above and other aspects of the invention will become better understood with regard to the following detailed description of the preferred but non-limiting embodiments. The following description is made with reference to the accompanying drawings.

### BRIEF DESCRIPTION OF THE DRAWINGS

FIG. 1 is a top view of a conventional mutual capacitive touch sensing device;

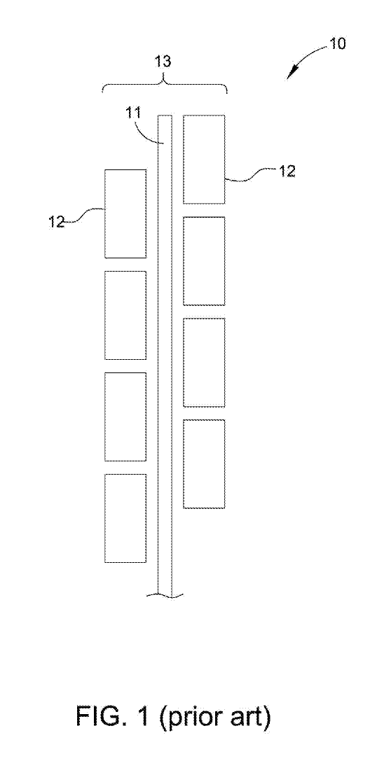

FIG. 2 is a top view of touch sensing units of a conventional mutual capacitive touch sensing device;

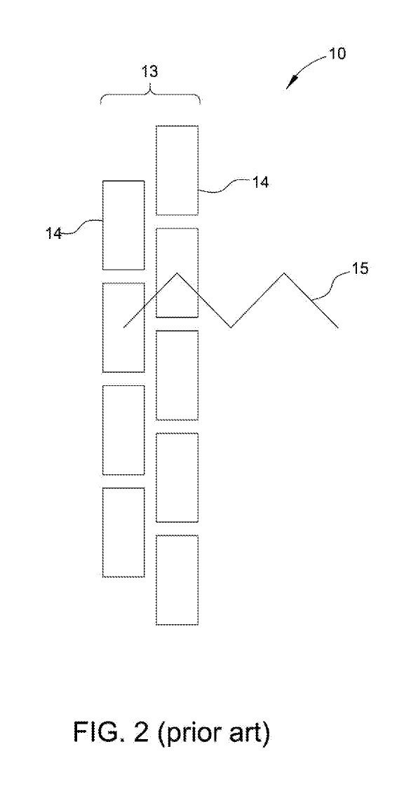

FIG. 3 is a top view of a touch panel according to a first embodiment of the present invention;

FIG. 4 is a top view of a touch sensing group according to the first embodiment of the present invention;

FIG. 5 is a top view of a touch sensing group according to a variation of the first embodiment of the present invention;

FIG. 6 is a top view of a mutual capacitive touch sensing device according to a variation of the first embodiment of the present invention;

FIG. 7 is a top view of a touch sensing group according to a second embodiment of the present invention;

FIG. 8 is a top view of a touch sensing group according to a third embodiment of the present invention;

FIG. 9 is a top view of a touch sensing group according to a fourth embodiment of the present invention;

FIG. 10 is a top view of a touch sensing group according to a fifth embodiment of the present invention; and

FIG. 11 is a top view of a touch sensing group according to a sixth embodiment of the present invention.

### DETAILED DESCRIPTION OF THE INVENTION

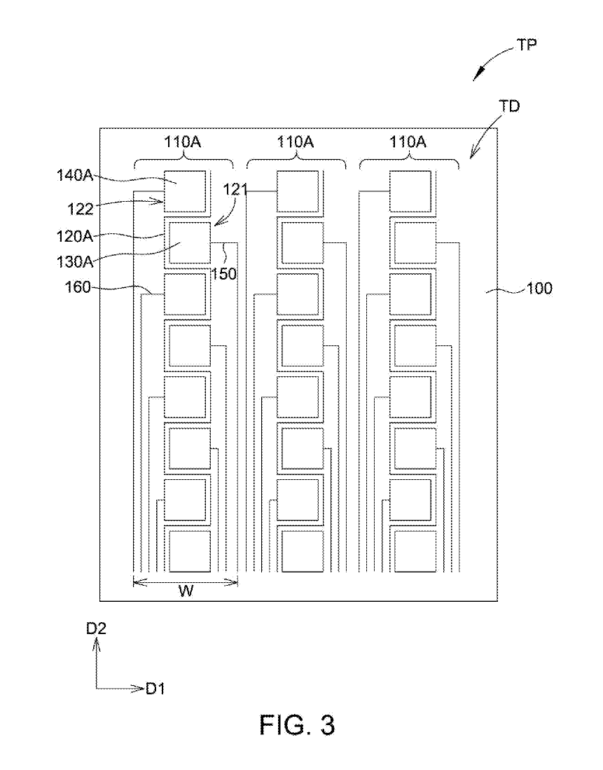

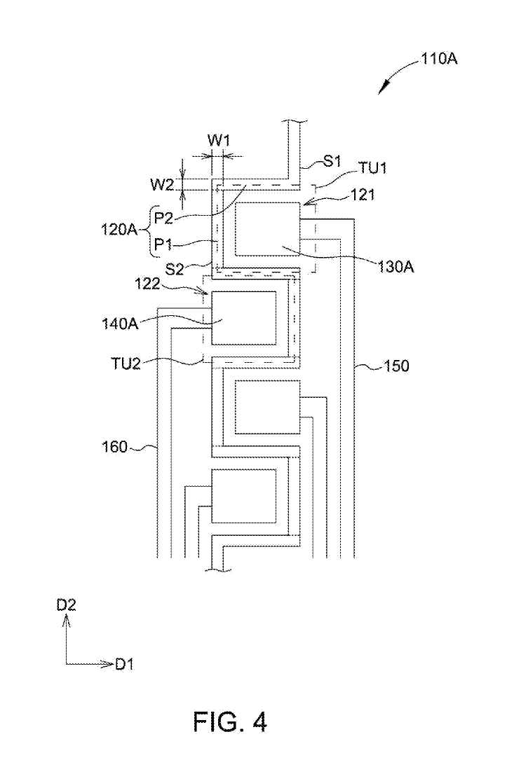

FIG. 3 shows a top view of a touch panel according to a first embodiment of the present invention. FIG. 4 shows a top view of a touch sensing group according to the first embodiment of the present invention. As shown in FIG. 3 and FIG. 4, a touch panel TP includes a substrate 100 and a mutual capacitive touch sensing device TD. The mutual capacitive touch sensing device TD is disposed on a substrate 100, and includes a plurality of touch sensing groups 110A arranged along a first direction D1. Each of the touch sensing groups 110A may include a plurality of first touch sensing units TU1 and a plurality of second touch sensing units TU2, with the first touch sensing units TU1 and second touch sensing units TU2 sequentially and alternately arranged along a second direction D2. In the same touch sensing group 110A, one first touch control unit TU1 and one adjacent second touch control unit TU2 do not overlap in the first direction D1. Thus, when a touch object moves in a straight line along the first direction D1, a ratio of a sensing amount of the first touch control unit TU1 for the touch object to a sensing amount of the second touch control unit TU2 for the touch object is kept consistent, hence preventing a detected motion track from deviating the actual motion track of the touch object.

Each of the touch sensing groups 110A may include a first electrode 120A, a plurality of second electrodes 130A and a plurality of third electrodes 140A. Each first electrode 120A in a serpentine shape is disposed on the substrate 100, and is arranged along the first direction D1. Each first electrode 120A includes a first side S1 and a second side S2 that are opposite. The first side S1 includes a plurality of indentations, and the second side S2 includes a plurality of indentations 122, with the first indentations 121 and the second indentations 122 sequentially alternately arranged along the second direction D2. More specifically, the first electrode 120A may include a plurality of first strip portions P1 and a plurality of second strip portions P2. The first strip portions P1 are arranged along the second direction D2, the second strip portions P2 are arranged along the first direction D1, and two ends of each second strip portion P2 are respectively connected to two first strip portions P1, in a way that the first strip portions P1 and the second strip portions P2 are sequentially alternately arranged to form the first electrode 120A in a serpentine shape. As such, two second strip portions P2 and one first strip portion 122 may form one first indentation 121 or one second indentation 122, and the first indentations 121 and the second indentations 122 respectively face opposite directions. In this embodiment, for example, the first direction D1 and the second direction D2 may be perpendicular to each other, e.g., the X-axis and the Y-axis, or vice versa. The second electrodes 130A are disposed facing the first side S1 of the first electrode 120A, and are respectively disposed in the corresponding first indentations 121 and electrically insulated from the first electrode 120A. Thus, each second electrode 130A and the corresponding part of the first electrode 120A form one first touch sensing unit TU1. The third electrodes 140A are disposed facing the second side S2 of the first electrode 120A, and are respectively disposed in the corresponding second indentations 122 and electrically insulated from the first electrode 120A. Thus, each third electrode 140A and the corresponding part of the first electrode 120A form one second touch sensing unit TU2. In the embodiment, for example but not limited to, the first electrode 120A may serve as a sensing electrode, and the second electrodes 130A and the third electrodes 140A may serve as driving electrodes. In another embodiment, the first electrode 120A may serve as a driving electrode, and the second electrodes 130A and the third electrodes 140A may serve as sensing electrodes. It should be noted that, as the second strip portions P2 are disposed along the first direction D1, the first indentation 121 and the adjacent second indentation 122 do not overlap in the first direction D1, such that the second electrode 130A in the first indentation 121 and the third electrode 140A in the second indentation 122 do not overlap in the first direction D1, either. That is to say, for any straight line along the first direction D1, there is only one second electrode 130A or one third electrode 140A in each touch sensing group 110A. Thus, when a touch object moves along a straight line in the first direction D1, a ratio of a coupling area of the touch object and the corresponding second electrode 130A to a coupling area of the touch object and the corresponding third electrode 140A is kept consistent. Therefore, the motion track detected by the mutual capacitive sensing device TD may match or approximate the actual motion track of the touch object, hence enhancing the accuracy of touch sensing. For example, assume that a touch object moves from a left position, at which the coupling area of the corresponding second electrode 130A is identical to the coupling area of the corresponding third electrode 140A, to the right in a straight line along the first direction D1. During the process of moving, the two coupling areas above are maintained substantially equal. Further, in the embodiment, the second electrodes 130A and the third electrodes 140A are alternately arranged along the second direction D2, and both are slightly displaced in the first direction D1. The above arrangement is for adapting to the serpentine shape of the first electrode 120A, so as to reduce areas unfilled by electrodes in the touch sensing group 110A to provide the touch sensing group 110A with a more regular shape.

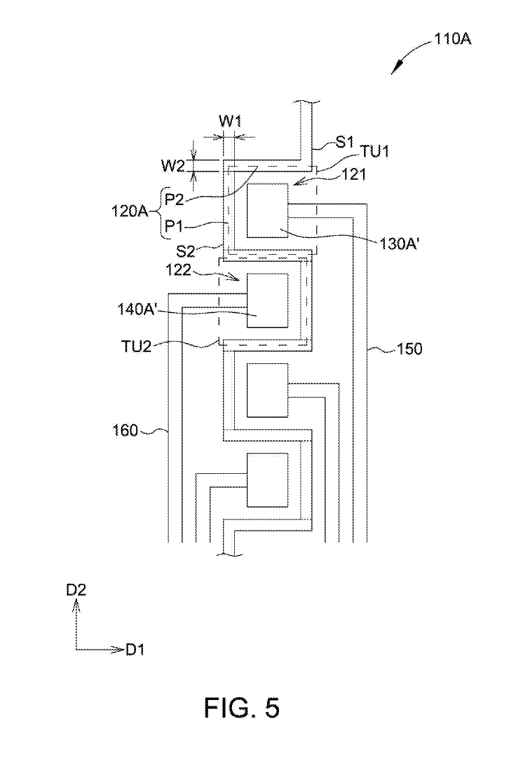

In another embodiment, as shown in FIG. 5, second electrodes 130A′ and third electrodes 140A′ are not displaced in the first direction D1, such that the second electrodes 130A′ and the third electrodes 140A′ completely overlap in the second direction D2. Thus, when a touch object overlaps the second electrode 130A′ and the adjacent third electrode 140A′, the position of the touch object detected does not contain any deviation in the first direction D1 because the second electrode 130A′ and the third electrode 140A′ are not displaced in the first direction D1, thereby enhancing the detection accuracy of a touch sensing group 110A with respect to the second direction D2. In this embodiment, the first electrode 120A, the second electrodes 130A and the third electrodes 140A may be formed from the same transparent conductive layer through patterning. For example for not limited to, the transparent conductive layer may include a transparent conductive material, e.g., indium tin oxide (ITO), indium zinc oxide (IZO) and aluminum zinc oxide (AZO). The side of each second electrode 130A facing the first electrode 120A may have the same shape as the first indentation 121, and the side of each third electrode 140a facing the first electrode 120A may have the same shape as the second indentation 122. For example but not limited to, the second electrodes 130A and the third electrodes 140A may be rectangles, or other geometric shapes. Further, the substrate 100 may include a hard substrate or a flexible substrate, e.g., a glass substrate, a tampered glass substrate, a quartz substrate, a sapphire substrate, a hard cover lens, a plastic substrate, a flexible cover plate, a flexible plastic substrate, a thin glass substrate or a substrate of a display device. For example but not limited to, the substrate of a display device may be a color filter substrate of a liquid crystal display (LCD) or a package cover plate of an organic light emitting display (OLED).

Each of the touch sensing group 110A may further include a plurality of first conducting lines 150 and a plurality of second conducting lines 160. Each of the first conducting lines 150 may connect to one corresponding second electrode 130A, and each of the second conducting lines 160 may connect to one corresponding third electrode 140A. Thus, the second electrodes 130A and the third electrodes 140A may electrically connect to connecting pads through the respective first conducting lines 150 and second conducting lines 160 to further electrically connect to control elements. In this embodiment, for example but not limited to, the first conducting lines 150 and the second conducting lines 160 extend towards the same side of the substrate 100 along the second direction D2. A width W of each touch sensing group 110A in the first direction D1 may define a gap between an outer side of the outermost first conducting line 150 and an outer side of the outermost second conducting line 160. The width W of each touch sensing group 110A in the first direction D1, e.g., 5 mm, is smaller than the width of a touch object, so as to help identify the position of the touch object. For example but not limited to, the touch object may be a finger or a stylus. It should be noted that, under different operating frequencies, to prevent the attenuation of signals of the first touch sensing units TU1 and the second touch sensing units TU2 of the same touch sensing group 110A as a distance of one end of the first electrodes 120A that transmit the signals gets farther, preferably, in this embodiment, a width W1 of the first strip portions P1 in the first direction D1 is greater than a width W2 of the second strip portions P2 in the second direction D2. For example, the width W1 of the first strip portions P1 may be approximately 0.45 mm, and the width W2 of the second strip portions P2 may be approximately 0.4 mm.

The mutual capacitive touch sensing device of the present invention is not limited to the above embodiment. In the description below, the mutual capacitive touch sensing device according to other embodiments and variations of these embodiments of the present invention are sequentially illustrated. To compare distinctions among the embodiments and the variations of these embodiments and to keep the description simple, the same elements are represented by the same denotations in the embodiments and the variations of these embodiments, and details of repeated parts shall be omitted.

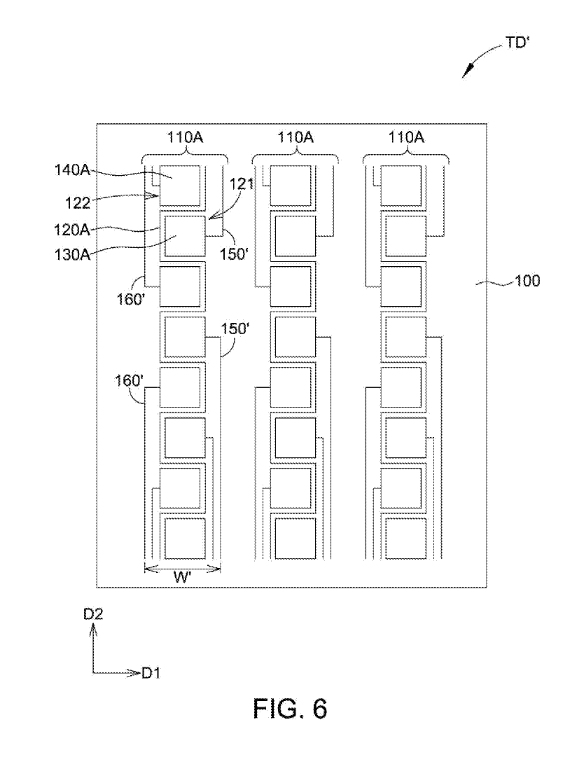

FIG. 6 shows a top view of a mutual capacitive touch sensing device according to a variation of the first embodiment of the present invention. As shown in FIG. 6, compared to the first embodiment, in this variation, first conducting lines 150′ and second conducting lines 160′ may respectively extend towards two opposite sides of the substrate 100. More specifically, a part of the first conducting lines 150′ and a part of the second conducting lines 160′ are connected to the second electrodes 130A and the third electrodes 140A that are closer to the first side of the substrate 100, and extend along the second direction D2 towards the first side of the substrate 100. Further, the remaining part of the first conducting lines 150′ and the remaining part of the second conducting lines 160′ are connected to second electrodes 130A and the third electrodes 140A that are closer to the second side of the substrate 100, and extend along the direction opposite to the second direction D2 towards the second side of the substrate 100. Thus, compared to the first embodiment in which the first conducting lines 150 and the second conducting lines 160 extending toward the same side of the substrate 100, the number of the first conducting lines 150′ and the second conducting lines 160′ extending towards the same side of the substrate 100 in this variation may be reduced. Thus, the distribution width of the first conducting lines 150′ and the second conducting lines 160′ in the first direction D1 may be reduced, so as to reduce a width W′ of the touch sensing groups 100A in the first direction D1 and enhance the accuracy of a mutual capacitive touch sensing device TD′.

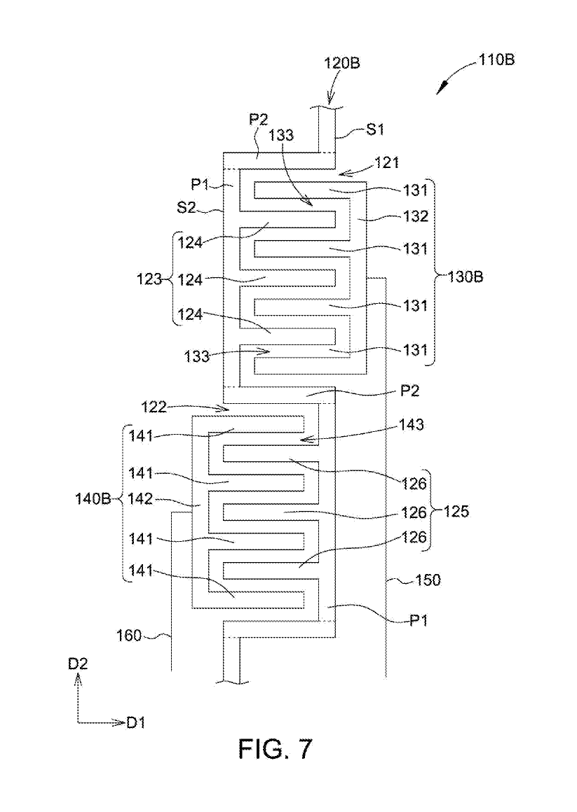

FIG. 7 shows a top view of a touch sensing group according to a second embodiment of the present invention. As shown in FIG. 7, compared to the first embodiment, the shapes of a first electrode 120B, second electrodes 130B and third electrodes 140B of this embodiment may be different from those of the first embodiment. Similarly, in this embodiment, for example but not limited to, the first electrode 120B may serve as a sensing electrode, and the second electrodes 130B and the third electrodes 140B may serve as driving electrodes. In a variation of this embodiment, the first electrode 120B may serve as a driving electrode, and the second electrodes 130B and the third electrodes 140B may serve as sensing electrodes. One person skilled in the art can understand that such operation characteristic is applicable to all embodiments of the present invention, and associated details shall be omitted herein. In a touch sensing group 110B of this embodiment, each second electrode 130B includes a plurality of electrode fingers 131, and the first electrode 120B includes a plurality of second electrode fingers 124, with each second electrode finger 124 extended into two adjacent first electrode fingers 131. More specifically, in addition to the first electrode fingers 131, each of the second electrodes 130B may further include a first connecting portion 132 disposed along the second direction D2. The first electrode fingers 131 are disposed along the first direction D1, and are connected to the first connecting portion 132. Further, the first electrode fingers 131 extend from one side of the first portion 132 facing the first indentation 121 to form a comb structure disposed facing the first indentation 121, and a first gap 133 is formed between two adjacent first electrode fingers 131. Thus, the first gaps 133 are also disposed along the first direction D1. In addition to the first strip portions P1 and the second strip portions P2, each of the first electrodes 120B may further included a plurality of first electrode finger groups 132, which are respectively disposed in the corresponding first indentations 121. Each of the first electrode finger groups 123 includes a plurality of second electrode fingers 124 disposed along the first direction D1. In this embodiment, the second electrode fingers 124 of each first electrode finger group 123 respectively extend from the first strip portions P1 at the bottom of the corresponding first indentations 121 to the corresponding first gaps 133. Thus, each strip portion P1 corresponding to one first indentation 121 and the second strip portions P2 and the second electrode fingers 124 connected to the first strip portion P1 may form another comb structure. Further, in the first indentations 121, the first electrode fingers 131 and the second electrode fingers 124 are alternately arranged along the second direction D2.

Similarly, each third electrode group 140B of each touch sensing group 110B includes a plurality of third electrode fingers 141, and the first electrode 120B includes a plurality of fourth electrode fingers 126 each extending between two adjacent third electrode fingers 141. More specifically, in addition to the third electrode fingers 141, each third electrode 140B may further include a second connecting portion 142 disposed along the second direction D2. The third electrode fingers 141 are disposed along the first direction D1, and are connected to the first connecting portion 142. The third electrode fingers 141 extend out from one side of the second portion 142 facing the second indentation 122 to form a comb structure disposed facing the second indentation 122. Further, a second gap 143 is formed between every two adjacent second electrode fingers 141. Thus, the second gaps 143 are also disposed along the first direction D1. Each of the first electrodes 120B further includes a plurality of second electrode finger groups 125, which are respectively disposed in the corresponding second indentations 122. Each second electrode group 125 includes a plurality of fourth electrode fingers 126 disposed along the first direction D1. In this embodiment, the fourth electrode fingers 126 respectively extend from the first strip portions P1 at the bottom of the corresponding second indentation 122 along a direction opposite to the first direction D1 into the corresponding second gaps 143. Thus, the first strip portion P1 corresponding to the second indentations 122 and the second strip portions P2 and the fourth electrode fingers 126 connected to these first strip portion P1 may form another comb structure. Further, in the second indentations 122, the third electrode fingers 141 and the fourth electrode fingers 126 are alternately arranged along the second direction D2. It should be noted that, with the design of an alternate arrangement of the comb structure of the first electrode 120B, the comb structures of the second electrodes 130B and the comb structures of the third electrodes 140B, respective coupling capacitances among the first electrode 120B, the second electrodes 130B and the third electrodes 140B are increased to further increase the sensing amount of touch control signal. In another embodiment, the shapes of the second electrodes 130B or the third electrodes 140B of the touch sensing group 110B may be identical to those of the first embodiment.

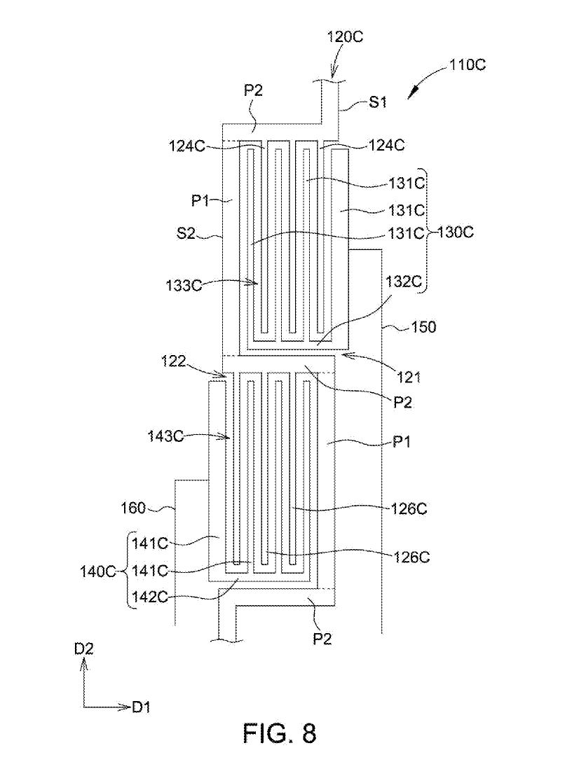

FIG. 8 shows a top view of a touch sensing group according to a third embodiment of the present invention. As shown in FIG. 8, compared to the second embodiment, first, second, third and fourth electrode fingers 131C, 124C, 141C and 126C in the third embodiment are disposed along the second direction D2. More specifically, in the touch sensing group 110C provided by this embodiment, the second electrode fingers 124C extend along the section direction D2 from one of the second strip portions P2 that serves as a sidewall of one first indentation 121, and are not connected to the of the other second strip portion P2 of that first indentation 121. A first connecting portion 132C of each second electrode 130C extends along the first direction D1 into the corresponding first indentation 121, and is located between the second electrode finger 124C and the second strip portion P2 that is not connected. The first electrode fingers 131C of each second electrode 130C extend along the second direction D2 from the first connecting portion 132C to form first gaps 133C disposed along the second direction D2. Further, each second electrode finger 124C extends into the first gap 133C of any two adjacent first electrode fingers 131C, such that the first electrode fingers 131C and the second electrode fingers 124C are alternately arranged along the first direction D1. Similarly, the fourth fingers 126C extend along the second direction D2 from one of the second strip portions P2 that serves as a sidewall of each second indentation 122 and do not connect to the other second strip portion P2 of that second indentation 122. A third connecting portion 142C of each third electrode 140C extends along the first direction D1 into the second indentation 122, and is located between the fourth electrode finger 126C and the second strip portion P2 that is not connected. The third electrode fingers 141C of each third electrode 140C extend out along the second direction D2 from the second connecting portion 142C to form second gaps 143C disposed along the second direction D2. Each fourth 126C extends into one second gap 143C between any two adjacent third electrode fingers 141C, such that the third electrode fingers 141C and the fourth electrode fingers 126C are alternately arranged along the first direction D1.

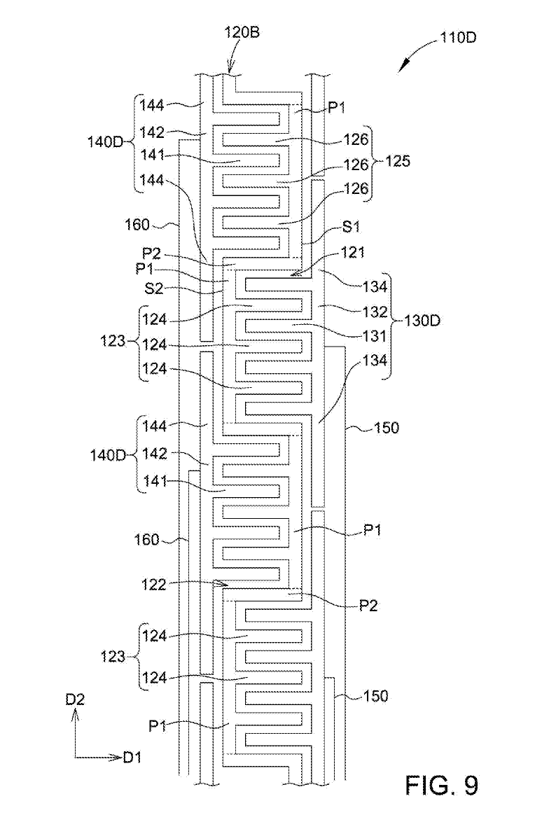

FIG. 9 shows a top view of a touch sensing group according to a fourth embodiment of the present invention. As shown in FIG. 9, compared to the second embodiment, each of second electrodes 130D and each of third electrodes 140D of the touch sensing group 110D in the fourth embodiment may further include a shielding portion. The shielding portions are disposed among the first electrodes 120B, the first conducting lines 150 and the second conducting lines 160, and are for preventing the first conducting line 150 connected to the non-corresponding second electrode 130D and the second conducting line 160 connected to the non-corresponding third electrode 140D from generating capacitance coupling with the first electrode 120B, so as to enhance the accuracy of the touch sensing device. In this embodiment, each of the second electrode 130D may include at least one first shielding portion 134, which extends out of the first indentations 121 and is located between the first conducting line 150 and the first electrode 120B. More specifically, each second electrode 130D may include two first shielding portions 134 extending along the second direction D2 respectively from two ends of the first connecting portion 131. Further, the first strip portion P1 corresponding to the second indentation 122 is disposed between the first shielding portions 134 and the corresponding third electrode 140D. Taking two adjacent second electrodes 130D of the same touch sensing group 110D for example, the first shielding portions 134 extending to an outer side of the same first strip portion P1 are separated and electrically insulated from each other. Preferably, the first shielding portions P1 may extend close to a center of the corresponding first strip portion 134 to effectively shield the capacitance coupling between the corresponding first strip portion P1 and the first conducting line 150 that is not electrically connected to the two. Similarly, each of the third electrodes 140D includes at least one second shield portion 144, which extends out of the second indentations 122 and is located between the second conducting line 160 and the first electrode 120B. More specifically, each third electrode 140D may include two second shielding portions 144 extending out along the second direction D2 respective from two ends of the second connecting portion 142. Further, the first strip portion P1 corresponding to the first indentation 121 is disposed between the second shielding portions 144 and the corresponding second electrode 130D. Taking two adjacent third electrodes 140D of the same touch sensing group 110D for example, the second shielding portions 144 extending to the outer side of the same first strip portion P1 are separated and electrically insulated from each other. Preferably, the second shielding portions 144 may extend close to a center of the corresponding first strip portion P1 to effectively shield the capacitance coupling between the corresponding first strip portion P1 and the second conducting line 160 that is not electrically connected to the two, hence preventing the accuracy of the mutual capacitive touch sensing device from being affected. In a variation of this embodiment, the first shielding portions 134 and the second shielding portions 144 may also be applied to the first electrode and the second electrodes in the first embodiment and the third embodiment.

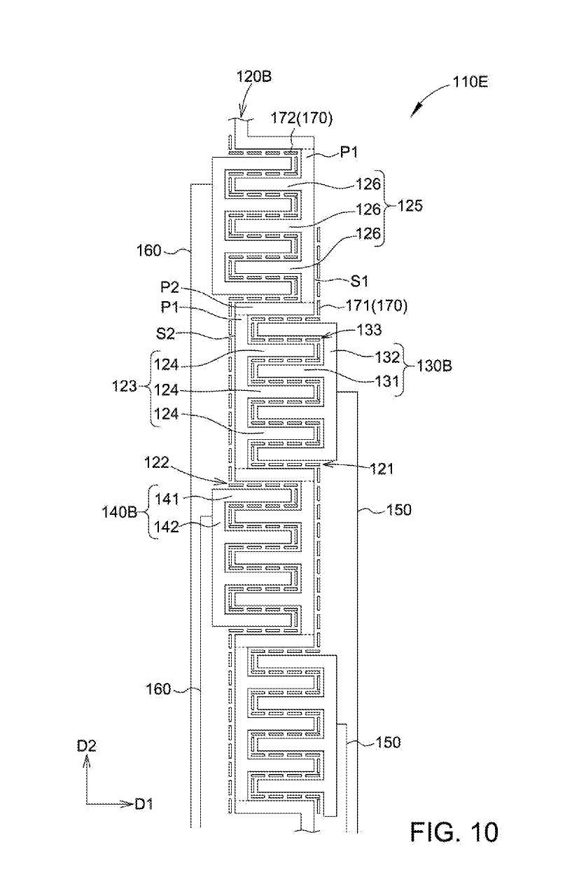

FIG. 10 shows a top view of a touch sensing group according to a fifth embodiment of the present invention. As shown in FIG. 10, compared to the second embodiment, in a touch sensing group 110E of the fifth embodiment, the touch sensing group 110E further includes a plurality of floating electrodes 170, which are disposed between the first electrode 120B and the second electrodes 130B and between the first electrode 120B and the third electrodes 140B. In this embodiment, a width of the floating electrodes 170 in the second direction D2 is smaller than a width of the second electrodes 130B in the second direction and a width of the third electrodes 140B in the second direction. The floating electrodes 170 may be divided into first floating electrodes 171 and second floating electrodes 172. The first floating electrodes 171 are disposed between the first electrode 120B and the second electrodes 130B, and are sequentially arranged between the gaps of the first electrode 120B and the second electrodes 130B. For example, as the second electrode fingers 124 of the first electrode 120B are inserted into the first gaps 133 of the second electrodes 130B, the gaps between the first electrode 120B and the second electrodes 130B are in a serpentine shape, and so the first floating electrodes 171 are sequentially arranged in a serpentine shape as well in the gaps. Further, a part of the first floating electrodes 171 may be disposed between the first strip portions P1 corresponding to the second indentations 122 and the first conducting lines 150. Similarly, the second floating electrodes 172 may be sequentially arranged in a serpentine shape in the gaps between the first electrode 120B and the third electrodes 140B, and a part of the second floating electrodes 172 may be disposed between the first strip portions P1 corresponding to the first indentations 121 and the second conducting lines 160. It should be noted that, by disposing the floating electrodes 170 between the first electrode 120B and the second electrodes 130B and between the first electrode 120B and the third electrodes 140B, the sensing amount of capacitance coupling among the first electrode 120B, the second electrodes 130B and the third electrodes 140B may be effectively increased to further enhance the touch sensitivity. In a variation of the embodiment, the floating electrodes may also be applied to the touch sensing groups of the first embodiment, the third embodiment and the fourth embodiment.

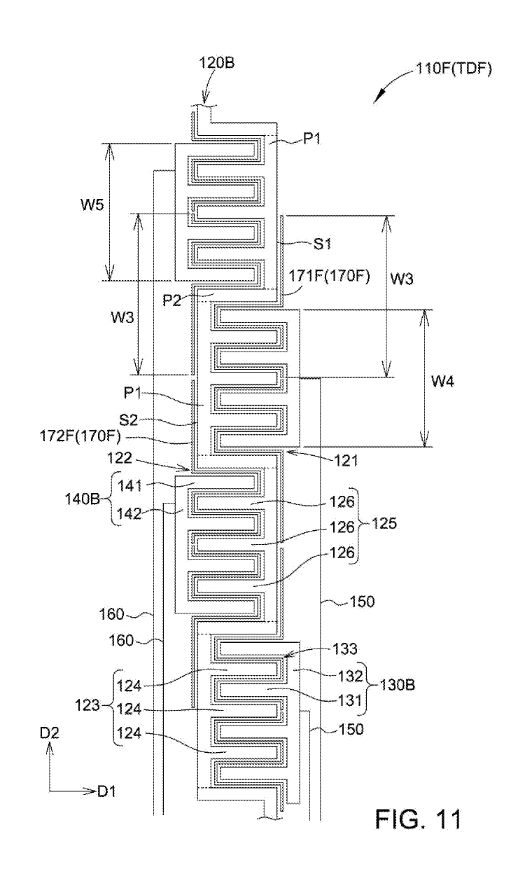

FIG. 11 shows a top view of a touch sensing group according to a sixth embodiment of the present invention. As shown in FIG. 11, compared to the fifth embodiment, in a touch sensing group 110F of the sixth embodiment, the same floating electrode 170F may overlap the adjacent second electrode 130B and third electrode 140B in the first direction D1. That is to say, a first floating electrode 171F extends from a gap between the first electrode and one corresponding second electrode 130B to an outer side of the first strip portion P1 outside the first indentation 121, and a second floating electrode 172F extends from a gap between the first electrode 120B and one corresponding third electrode 140B to an outer side of the first strip portion P1 outside the second indentation 122. Further, a part of the each of the floating electrodes 170F may be in a serpentine shape. Preferably, a width W3 of the floating electrodes 170F in the second direction D2 may be equal to a width W4 of the second electrodes 130B in the second direction and a width W5 of the third electrodes 140B in the second direction D2. That is to say, an overlapping length, in the first direction D1, of each floating electrode 170 with the adjacent second electrode 130B may be equal to an overlapping length, in the first direction D1, of each floating electrode 170F with the adjacent third electrode 140B. It should be noted that, because a touch object is greater than the width of the touch sensing groups 110F in the first direction D1, i.e., greater than the widths of the first touch sensing units and the second touch sensing units, in order to have a mutual capacitive touch sensing device TDF to more accurately identify the position of the touch object, signals sensed by touch sensing units in a 3×3 array are usually used to determine the position of the touch object. Therefore, through the overlapping design of the floating electrodes 170F and the adjacent second electrode 130B and third electrode 140B in the first direction D1, the size of the signals sensed by the touch sensing units in a 3×3 array can be effectively increased to further enhance the accuracy of the mutual capacitive touch sensing device TDF. For example, with the mutual capacitive touch sensing unit TDF of this embodiment, the size of a sensing signal is increased by approximately 10%.

In conclusion, in the mutual capacitive touch sensing device of the present invention, as the first electrode is in a serpentine shape, the first indentation and the second indentation that are adjacent to each other do not overlap in the first direction, in a way that the first touch sensing unit and the second touch sensing unit formed do not overlap in the first direction either. Thus, when a touch object moves in a straight line along the first direction, the ratio of the coupling area of the touch object and the first touch sensing unit to the coupling area of the touch object and the second touch sensing unit is kept consistent. As a result, the motion track detected by the mutual capacitive touch sensing device matches or approximates the actual motion track of the touch object, thereby enhancing the accuracy of touch sensing and preventing the issue of a detected motion track deviating from the actual motion track of the touch object.

While the invention has been described by way of example and in terms of the preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A mutual capacitive touch sensing device of a touch panel, disposed on a substrate, the mutual capacitive touch sensing device being a single-layer structure, comprising at least one touch sensing group arranged along a first direction on the substrate, wherein the at least one touch sensing group comprises:
a first electrode, disposed on the substrate in a serpentine shape, the first electrode comprising a first side and a second side that are opposite each other, the first side comprising a plurality of first indentations, the second side comprising a plurality of second indentations; wherein, the first indentations and the second indentations are alternately arranged along a second direction, and one of the first indentations and one of the second indentations that are adjacent to each other do not overlap in the first direction;
a plurality of second electrodes, disposed facing the first side of the first electrode, respectively disposed in the corresponding first indentations; and
a plurality of third electrodes, disposed facing the second side of the first electrode, respectively disposed in the corresponding second indentations.

2. The mutual capacitive touch sensing device according to claim 1, wherein each of the second electrodes comprises a plurality of first electrode fingers, the first electrode comprises a plurality of second electrode fingers, and one of the second electrode fingers extends into two of the first electrode fingers that are adjacent.

3. The mutual capacitive touch sensing device according to claim 2, wherein the first electrode fingers and the second electrode fingers are disposed along the first direction.

4. The mutual capacitive touch sensing device according to claim 2, wherein the first electrode fingers and the second electrode fingers are disposed along the second direction.

5. The mutual capacitive touch sensing device according to claim 2, wherein each of the third electrode comprises a plurality of third electrode fingers, the first electrode comprises a plurality of fourth electrode fingers, and one of the fourth electrode fingers extends into two of the third electrode fingers that are adjacent.

6. The mutual capacitive touch sensing device according to claim 1, wherein the first electrode comprises a plurality of first strip portions and a plurality of second strip portions, the first strip portions are disposed along the second direction, the second strip portions are disposed along the first direction, the first strip portions and the second strip portions of the first electrode are sequentially alternately connected, and the plurality of second electrodes and the plurality of third electrodes are displaced in the first direction.

7. The mutual capacitive touch sensing device according to claim 1, wherein the at least one touch sensing group further comprises:
a plurality of first conducting lines, respectively electrically connected to the corresponding second electrodes; and
a plurality of second conducting lines, respectively electrically connected to the corresponding third electrodes.

8. The mutual capacitive touch sensing device according to claim 7, wherein each of the second electrodes comprises at least one first shielding portion, which extends out of the first indentations and is located between the first conducting lines and the first electrode.

9. The mutual capacitive touch sensing device according to claim 7, wherein each of the third electrodes comprises at least one second shielding portion, which extends out of the second indentations and is located between the second conducting lines and the first electrode.

10. The mutual capacitive touch sensing device according to claim 7, wherein the first conducting lines and the second conducting lines extend towards one side of the substrate.

11. The mutual capacitive touch sensing device according to claim 7, wherein a part of the first conducting lines and a part of the second conducting lines extend towards one side of the substrate, and the remaining part of the first conducting lines and the remaining part of the second conducting lines extend towards one other side of the substrate opposite to the one side.

12. The mutual capacitive touch sensing device according to claim 1, wherein the at least one touch sensing group further comprises a plurality of floating electrode, which are disposed between the first electrode and the second electrodes and between the first electrode and the third electrodes.

13. The mutual capacitive touch sensing device according to claim 12, wherein one of the floating electrodes overlaps in the first direction with one of the second electrodes and one of the third electrodes that are adjacent.

14. The mutual capacitive touch sensing device according to claim 12, wherein a part of each of the floating electrodes is in a serpentine shape.

15. The mutual capacitive touch sensing device according to claim 12, wherein a width of the floating electrodes in the second direction is equal to a width of each of the second electrodes in the second direction and a width of each of the third electrodes in the second direction.

16. The mutual capacitive touch sensing device according to claim 12, wherein a width of each of the floating electrodes in the second direction is smaller than a width of each of the second electrodes in the second direction and a width of each of the third electrodes in the second direction.

17. The mutual capacitive touch sensing device according to claim 1, wherein a width of each touch sensing group is smaller than a width of a touch object in the first direction.

18. The mutual capacitive touch sensing device according to claim 1, wherein the first electrode, the second electrodes and the third electrodes of the at least one touch sensing group are formed from a same transparent conductive layer through patterning.

19. The mutual capacitive touch sensing device according to claim 1, wherein the first electrode is a sensing electrode, and the second electrodes and the third electrodes are driving electrodes.

20. The mutual capacitive touch sensing device according to claim 1, wherein the first electrode is a driving electrode, and the second electrodes and the third electrodes are sensing electrodes.
